(19) United States
(12) Patent Application Publication
(10) Pub. No.: US 2021/0057976 A1
(43) Pub. Date: Feb. 25, 2021

(54) VIBRATION MOTOR

(71) Applicant: AAC Technologies Pte. Ltd., Singapore city (SG)

(72) Inventors: Kejia Liu, Shenzhen (CN); Yao Wang, Shenzhen (CN); Yun Tang, Shenzhen (CN); Ruizhi Lan, Shenzhen (CN); Rongrong Wu, Shenzhen (CN); Weimin Chen, Shenzhen (CN)

(21) Appl. No.: 16/993,283

(22) Filed: Aug. 14, 2020

(30) Foreign Application Priority Data
Aug. 23, 2019 (CN) PCT/CN2019/102298

(51) Int. Cl. H02K 33/12; H02K 33/02; H02K 33/18

(52) U.S. Cl. CPC H02K 33/12; B06B 1/045; H02K 33/18; H02K 33/02

(57) ABSTRACT

A vibration motor includes: a shell having an inner cavity; a vibrator; a magnetic component configured to drive the vibrator to vibrate; a first coil fixed to the shell; and a second coil fixed to the magnetic component. An alternating current applied to the first coil makes the vibrator to vibrate along the inner cavity. An adjustable current applied to the second coil makes a magnetic field of the magnetic component repel a magnetic field of the vibrator and provide a restoring force for the vibrator to reciprocate. A magnitude of the restoring force generated by the magnetic component is changed by adjusting a magnitude of the magnetic field of the magnetic component, to adjust a resonance frequency of the vibrator when the vibrator is vibrating. The resonance frequency of the vibration motor can be adjusted so that the vibration motor can have sufficiently high response in a wide frequency band.

### TECHNICAL FIELD

The present disclosure relates to the field of motor control technologies and, particularly, relates to a vibration motor.

### BACKGROUND

With the development of electronic technology, portable consumer electronic products such as mobile phones, handheld game machines, navigation apparatuses or handheld multimedia entertainment devices are increasingly popular, and vibration motors are generally used for system feedback in these products, such as mobile phone call prompt, information prompt, navigation prompt and vibration feedback of the game machines. In such a wide range of applications, there are higher requirements for the vibration performance of the vibration motors.

In smart devices, the motor often works at different frequencies according to different scenarios. The vibration motor can be simplified as a single freedom degree system, which has a large response at a resonance frequency and a small response at a position away from the resonance frequency. Therefore, in order to ensure that the vibration motor has excellent vibration performance, it is required that the vibration motor has sufficiently high response in a wide frequency band.

The traditional method in which bandwidth is expanded by reducing the Q value through increasing damping has ran to its limitation, and thus, its improvement space is limited. Therefore, it is necessary to provide a vibration motor with an adjustable resonance frequency.

### SUMMARY

A vibration motor with an adjustable resonance frequency is provided in such a manner that the vibration motor can have sufficiently high response in a wide frequency band.

In a first aspect, a vibration motor is provided. The vibration motor includes: a shell having an inner cavity; a vibrator that is magnetic and received in the inner cavity of the shell; at least one magnetic component received in the inner cavity of the shell, each of which is configured to drive the vibrator to vibrate; a first coil fixed to the shell; and at least one second coil, each of which is fixed to one of the at least one magnetic component. An alternating current is applied to the first coil in such a manner that the vibrator is driven to vibrate along the inner cavity of the shell. An adjustable current is applied to one of the at least one second coil in such a manner that a magnetic field generated by one of the at least one magnetic component repels a magnetic field generated by the vibrator, to provide a restoring force for the vibrator to reciprocate in the inner cavity of the shell. A magnitude of the restoring force generated by the one of the at least one magnetic component is changed by adjusting a magnitude of the magnetic field generated by the one of the at least one magnetic component, in such a manner that a resonance frequency of the vibrator when the vibrator is vibrating is adjusted.

As an improvement, in one embodiment, the vibration motor further includes covers provided at two ends of the shell, respectively. The at least one magnetic component includes two magnetic components that are respectively arranged at two inner ends of the shell, each of the two magnetic components is close to one of the covers, each of the two magnetic components is limited at one of the two inner ends of the shell by a limiting block, and the vibrator is capable of vibrating between the two limiting blocks.

As an improvement, in one embodiment, the vibrator is a permanent magnet.

As an improvement, the at least one magnetic component includes an iron core, the iron core is embedded in one second coil of the at least one second coil, and the adjustable current is applied to the one second coil in such a manner that a magnetic field generated by the iron core repels the magnetic field generated by the vibrator to provide the restoring force for the vibrator.

As an improvement, the at least one magnetic component includes an iron core-permanent magnet structure, the iron core-permanent magnet structure is formed by splicing an iron core and a permanent magnet and is embedded in one second coil of the at least one second coil, and the adjustable current is applied to the one second coil in such a manner that the magnetic field generated by the iron core-permanent magnet structure repels the magnetic field generated by the vibrator to provide the restoring force for the vibrator.

As an improvement, the magnitude of the restoring force generated by the one of the at least one magnetic component is changed by adjusting a magnitude of the adjustable current applied to the one second coil, in such a manner that the resonance frequency of the vibrator when the vibrator is vibrating is adjusted. Each one of the magnitude of the magnetic field generated by the one of the at least one magnetic component, the magnitude of the restoring force provided by the one of the at least one magnetic component to the vibrator, and the resonance frequency of the vibrator when the vibrator is vibrating increases as the magnitude of the adjustable current applied to the one second coil increases.

In a second aspect, a vibration motor is provided. The vibration motor includes: a shell having an inner cavity; a vibrator that is magnetic and received in the inner cavity of the shell; a magnetic component received in the inner cavity of the shell and configured to drive the vibrator to vibrate; an elastic component received in the inner cavity of the shell and arranged between the vibrator and the magnetic component; a first coil fixed to the shell; and a second coil fixed to the magnetic component. An alternating current is applied to the first coil in such a manner that the vibrator is driven to vibrate along the inner cavity of the shell, and the vibrator is driven by an elastic force generated by the elastic component to reciprocate in the inner cavity of the shell. An adjustable current is applied to the second coil in such a manner that a magnetic field generated by the magnetic component is changed to attract or repel a magnetic field generated by the vibrator, to provide an attracting force or a repelling force for the vibrator. The attracting force or the repelling force generated by the magnetic component is changed by adjusting a magnitude and a direction of the magnetic field generated by the magnetic component, in such a manner that a resonance frequency of the vibrator when the vibrator is vibrating is adjusted.

As an improvement, the direction of the magnetic field generated by the magnetic component is changed by adjusting a direction of the adjustable current applied to the second coil in such a manner that the resonance frequency of the vibrator when the vibrator is vibrating is adjusted. When a current with a first direction is applied to the second coil, the magnetic component generates the repelling force for the vibrator, and the resonance frequency of the vibrator when the vibrator is vibrating increases. When a current with a second direction is applied to the second coil, the magnetic component generates the attracting force for the vibrator, and the resonance frequency of the vibrator when the vibrator is vibrating decreases, and the second direction is opposite to the first direction.

As an improvement, the magnitude of the magnetic field generated by the magnetic component is changed by adjusting a magnitude of the adjustable current applied to the second coil in such a manner that the resonance frequency of the vibrator when the vibrator is vibrating is adjusted. Each one of the magnitude of the repelling force generated by the magnetic component for the vibrator and the resonance frequency of the vibrator when the vibrator is vibrating increases as the current with the first direction applied to the second coil increase. Each one of the magnitude of the attracting force generated by the magnetic component for the vibrator, and the resonance frequency of the vibrator when the vibrator is vibrating decreases as the current with the second direction applied to the second coil decreases.

As an improvement, the elastic component is a spring.

By arranging a magnetic vibrator and a magnetic component configured to drive the vibrator to vibrate in a cylindrical inner cavity of a shell, after being energized, the magnetic field generated by the magnetic component repels the magnetic field generated by the vibrator, which provides a driving force for the vibrator to resiliently move. The vibrator is driven to move in the direction of the driving force and reciprocates in the inner cavity of the shell. By adjusting the magnitude of the magnetic field generated by the magnetic component, the magnitude of the driving force generated by the magnetic component is changed, thereby adjusting the resonance frequency of the vibrator when the vibrator is vibrating. The resonance frequency of the vibration motor can be adjusted so that the vibration motor can have sufficiently high response in a wide frequency band. In this way, the vibration motor can adapt to the working frequency requirements under different working scenes, thereby achieving better vibration effects.

### BRIEF DESCRIPTION OF DRAWINGS

FIG. 1 is a sectional view of a vibration motor;

FIG. 2 is an overall schematic diagram of the vibration motor corresponding to FIG. 1;

FIG. 3 is a schematic diagram of a vibrator;

FIG. 4 is a schematic diagram of a principle of adjusting a resonance frequency of a vibration motor;

FIG. 5 is a sectional view of a vibration motor; and

FIG. 6 is a schematic diagram of a principle of adjusting a resonance frequency of a vibration motor.

### DESCRIPTION OF EMBODIMENTS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

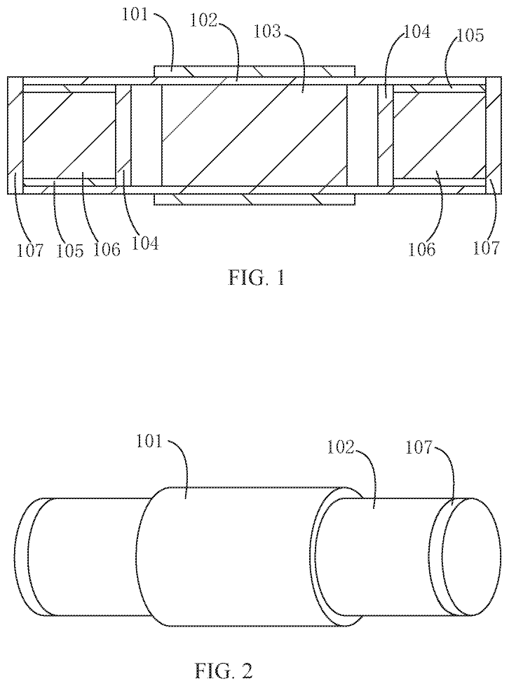

FIG. 1 is a sectional view of a vibration motor. FIG. 2 is an overall schematic diagram of the vibration motor corresponding to FIG. 1. The vibration motor has an adjustable resonance frequency, and thus can have sufficiently high response in a wide frequency band. Referring to FIG. 1 and FIG. 2, the vibration motor includes a shell 102 having a cylindrical inner cavity, and a vibrator 103 and a magnetic component that are received in the inner cavity of the shell 102. The vibrator 103 is magnetic, and the magnetic component is configured to drive the vibrator 103 to vibrate. A first coil 101 is fixed to the shell. In an embodiment, the first coil 101 is sleeved outside the shell 102. In another embodiment, the first coil 101 is arranged inside the shell 102. Covers 107 are arranged at two ends of the shell 107, respectively, in such a manner that the shell 102 forms a closed hollow structure. Each of magnetic components arranged at one of two ends inside the shell 102 is close to one of the cover 107, and the vibrator 103 is arranged between the two magnetic components. A second coil 105 is fixed to the magnetic component. In an embodiment, the magnetic component includes an iron core 106 embedded in the second coil 105.

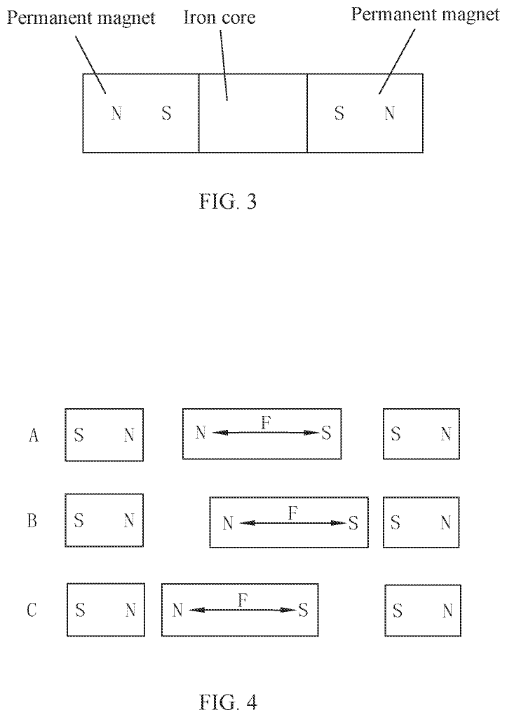

In the present embodiment, an alternating current is applied to the first coil 101, and the vibrator 103 is driven to vibrate along the inner cavity of the shell 102 by a reaction force of an ampere force, and the ampere force is a force applied to the first coil. An inner wall surface of the shell 102 is smooth. Since the vibrator 103 is magnetic, when the alternating current is applied to the first coil 101, a driving force is provided to the vibrator 103 to drive the vibrator to reciprocate. Thus, the vibrator 103 is driven to slide inside the shell 102. The vibrator 103 is a mass block. That is, the vibrator 103 is a block object with a certain mass. In an embodiment, the vibrator 103 is a permanent magnet. It can be understood that the vibrator can be a whole permanent magnet or can be formed by splicing a plurality of permanent magnets. As shown in FIG. 3, the vibrator can be structurally composed of permanent magnets at both sides and an iron core sandwiched therebetween, and same electrodes of the permanent magnets at both sides are opposite to each other. That is, the vibrator can be designed in the form of only permanent magnet, or in a form of a combination of the permanent magnet and the iron core, or in a form of a combination of a coil and the iron core, etc.

In an embodiment, the magnetic field generated by the magnetic component arranged inside the shell 102 provides a restoring force for the vibrator 103 to resiliently move. In an embodiment, an adjustable current is applied to the second coil 105 in such a manner that the magnetic field generated by the magnetic component repels the magnetic field generated by the vibrator 103, to provide a restoring force for the vibrator 103 to reciprocate to drive the vibrator 103 to move in a direction towards the restoring force. That is, the vibrator 103 is driven to move in a direction away from the magnetic component in such a manner that the vibrator 103 is driven to reciprocate in the inner cavity of the shell, and the vibrator 103 plays a role similar to a spring, which is equivalent to a “magnetic spring”.

In an embodiment, the magnitude of the restoring force generated by the magnetic component is changed by adjusting the magnitude of the magnetic field generated by the magnetic component, thereby adjusting the resonance frequency of the vibrator 103 when the vibrator is vibrating. In an embodiment, the magnitude of the restoring force generated by the magnetic component is changed by adjusting a magnitude of a current applied to the second coil 105, thereby adjusting the resonance frequency when the vibrator is vibrating. The larger the current applied to the second coil is, the stronger the magnetic field generated by the magnetic component will be, the greater the magnitude of the restoring force provided by the magnetic component to the vibrator will be, and the higher the resonance frequency of the vibrator when the vibrator is vibrating will be. Similar to the adjustment to the second coil 105, a stiffness of the “magnetic spring” can be adjusted. The larger the current is, the stronger the magnetic field generated by the magnetic component will be, the greater the stiffness of the “magnetic spring” will be, and the higher the resonance frequency of the motor will be.

In the vibration motor provided by the present embodiment, magnetic components are arranged at two ends inside the shell and close to the covers, respectively, a magnetic vibrator in a channel formed between the two magnetic components, the two magnetic components generate an electromagnetic restoring force for the vibrator after being energized. By adjusting the magnitude of the magnetic field generated by the magnetic component, the magnitude of the restoring force generated by the magnetic component is changed, thereby adjusting the resonance frequency of the vibrator when the vibrator is vibrating. The resonance frequency of the vibration motor can be adjusted in such a manner that the vibration motor can have sufficiently high response in a wide frequency band. The vibration motor can adapt to the working frequency requirements under different working scenes, thereby achieving better vibration effects.

In an embodiment, the magnetic component can include an iron core-permanent magnet structure. That is, the magnetic component is designed as the iron core-permanent magnet structure which is formed by splicing the iron core and the permanent magnet and is embedded in the second coil. The adjustable current is applied to the second coil in such a manner that the magnetic field generated by the iron core-permanent magnet structure repels the magnetic field generated by the vibrator to provide the resilient restoring force for the vibrator 103.

In an embodiment, referring to FIG. 1, each of two magnetic components is limited at one end inside the shell 102 by a limiting block 104, and the vibrator 103 vibrates between two limiting blocks 104. In an embodiment, the two limiting blocks 104 are symmetrically arranged inside the shell 102, in such a manner that the two magnetic components in the shell 102 provide balanced restoring forces for the vibrator 103.

In an embodiment, the first coil of the vibration motor is electrically connected to a first signal output terminal, and the second coils fixed to the two magnetic components of the vibration motor are electrically connected to second signal output terminals, respectively. In an embodiment, the first coil is a primary coil of the vibration motor, and the second coils are auxiliary coils fixed to the two magnetic components of the vibration motor. The primary coil is connected to a first power amplifying circuit through the first signal output terminal. The two auxiliary coils are connected to the second power amplifying circuit through the second signal output terminals. That is, the two auxiliary coils are controlled simultaneously by the second power amplifying circuit.

In an embodiment, the two second coils cam also be connected to two power amplifying circuits, respectively. That is, the two auxiliary coils are controlled by the two power amplifying circuits, respectively. In an embodiment, when the vibrator is away from one of the magnetic components, since the restoring force generated by the magnetic component to the vibrator is small, the magnetic component can be controlled to be de-energized at this time. While the vibrator is close to another magnetic component, the coil of the magnetic component is energized at this time to generate the magnetic field to provide the restoring force for the vibrator. The restoring force drives the vibrator to rebound to reciprocate, in such a manner that the resonance frequency when the vibrator is vibrating is adjusted.

FIG. 4 is a schematic diagram of a principle of adjusting a resonance frequency of a vibration motor. The structure of the vibration motor is simplified as that shown in FIG. 4, F represents the electromagnetic restoring force generated by the first coil. After the second coil is energized, the magnetic field generated by an electromagnet and the magnetic field generated by the vibrator repel each other, which provides an electromagnetic repelling force for the vibrator.

When in an A state, the electromagnetic forces (repelling forces) provided by the electromagnets at two sides to the vibrator are basically the same.

When in a B state, the vibrator moves to the right side to be close to the right electromagnet, the electromagnetic repelling force between the vibrator and the right electromagnet increases rapidly, the repelling force between the vibrator and the left electromagnet decreases, and a resultant force of the two repelling forces points to an original equilibrium position (i.e., the position where the vibrator is located in the A state).

When in a C state, the vibrator moves to the left side to be close to the left electromagnet, the electromagnetic repelling force between the vibrator and the left electromagnet increases rapidly, while the repelling force between the vibrator and the right electromagnet decreases, and a resultant force of the two repelling forces points to the original equilibrium position (i.e., the position where the vibrator is located in the A state).

It can be understood that the energized second coils at two sides of the vibration motor is equivalent to “magnetic springs”, each “magnetic spring” is equivalent to a nonlinear spring as the electromagnetic force is inversely proportional to a square of the distance.

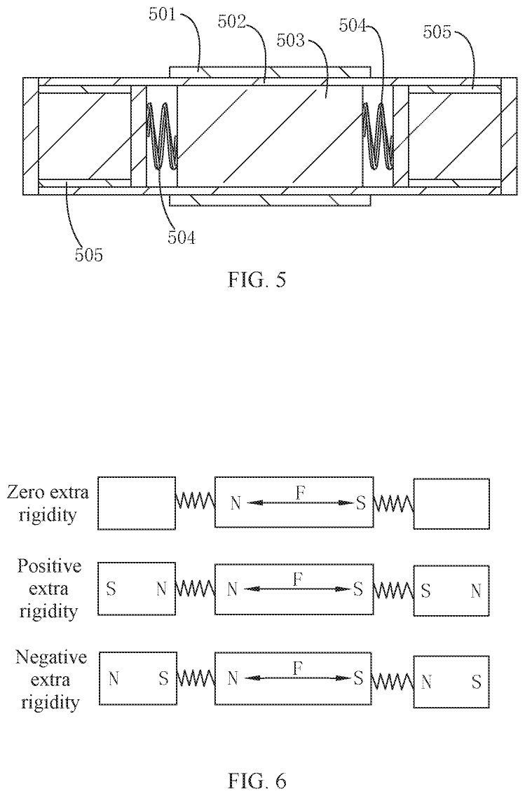

FIG. 5 is a sectional view of a vibration motor. As shown in FIG. 5, the vibration motor includes a shell 502 having an inner cavity, and a vibrator 503, a magnetic component, and an elastic component 504 that is received in the inner cavity of the shell 502. The vibrator is magnetic, and the magnetic component is configured to drive the vibrator 503 to vibrate and the vibrator 503. The elastic components 504 located between the vibrator 503 and the magnetic components. A first coil 501 is fixed to the shell 502, and a second coil 505 is fixed to the magnetic component.

An alternating current is applied to the first coil 501 to drive the vibrator 503 to vibrate along the inner cavity of the shell 502, in such a manner that the vibrator 503 is driven to reciprocate in the inner cavity of the shell 502 by an elastic force generated by the elastic components 504. An adjustable current is applied to the second coil 505 to change the magnetic field generated by the magnetic component, in such a manner that the magnetic field of the magnetic component repels or attracts the magnetic field generated by the vibrator 503, providing a repelling force or an attracting force for the vibrator 503. By adjusting a magnitude and a direction of the magnetic field generated by the magnetic component, the repelling force or the attracting force generated by the magnetic component is changed, in such a manner that the resonance frequency is adjusted when the vibrator 503 is vibrating. In an embodiment, the elastic component 504 is a spring. In another embodiment, the elastic component 504 can be other elastic components, such as an elastic piece, a rubber band and an air bag.

In an embodiment, by adjusting the direction of the current applied to the second coil 505, a direction of a driving force generated by the magnetic component is changed, so that the resonance frequency is adjusted when the vibrator 503 is vibrating.

FIG. 6 is a schematic diagram of a principle of adjusting a resonance frequency of a vibration motor. The structure of the vibration motor is simplified as that shown in FIG. 6, and a spring is provided between the vibrator and the magnetic component of the vibration motor to adjust the resonance frequency of the vibration motor by composited springs.

In an embodiment, when the second coil of the vibration motor is not energized, the vibration motor is equivalent to a conventional linear motor with zero extra rigidity. It can be understood that little extra rigidity can be generated due to magnetization of the iron core by the first coil and the vibrator.

When a current with a first direction is applied to the second coil, the electromagnet generates a repelling force for the vibrator. At this time, the repelling force generated by the electromagnet for the vibrator has a same direction as the elastic force generated by the spring, which is equivalent to providing extra positive rigidity. Thus, the resonance frequency of the vibrator increases when the vibrator is vibrating.

When a current with a second direction opposite to the first direction is applied to the second coil, the electromagnet generates an attracting force for the vibrator. At this time, the attracting force generated by the electromagnet for the vibrator has an opposite direction to a direction of the elastic force generated by the spring, which is equivalent to providing extra negative rigidity. Thus, the resonance frequency of the vibrator when the vibrator is vibrating decreases.

In an embodiment, the magnitude of the magnetic field generated by the magnetic component is changed by adjusting a magnitude of the current applied to the second coil, in such a manner that the resonance frequency of the vibrator when the vibrator is vibrating is adjusted. The larger the magnitude of the current with the first direction applied to the second coil is, the larger the magnitude of the repelling force generated by the magnetic component for the vibrator will be, and the higher the resonance frequency of the vibrator when the vibrator is vibrating will be. The larger the current with the second direction applied to the second coil is, the larger the magnitude of the attracting force generated by the magnetic component for the vibrator will be, and the lower the resonance frequency of the vibrator when the vibrator is vibrating will be.

Through composited springs, the vibration motor provided in the embodiments of the present disclosure can adjust the resonance frequency of the vibration motor more flexibly, thereby providing more functions.

The resonance frequency of the vibration motor can be adjusted so that the vibration motor can have sufficiently high response in a wide frequency band. In this way, the vibration motor can adapt to the working frequency requirements under different working scenes, thereby achieving better vibration effects.

The above is only the embodiments of the present invention and does not limit the patent scope of the present invention. Any equivalent structure or equivalent process transformation made by using the description and the accompany drawings of the present invention, or those directly or indirectly used in other related technical fields, are also included in the scope of protection of the present invention.

What is claimed is:

1. A vibration motor, comprising:
a shell having an inner cavity;
a vibrator that is magnetic and received in the inner cavity of the shell;
at least one magnetic component received in the inner cavity of the shell, each of which is configured to drive the vibrator to vibrate;
a first coil fixed to the shell; and
at least one second coil, each of which is fixed to one of the at least one magnetic component,
wherein an alternating current is applied to the first coil in such a manner that the vibrator is driven to vibrate along the inner cavity of the shell;
an adjustable current is applied to one of the at least one second coil in such a manner that a magnetic field generated by one of the at least one magnetic component repels a magnetic field generated by the vibrator, to provide a restoring force for the vibrator to reciprocate in the inner cavity of the shell; and
a magnitude of the restoring force generated by the one of the at least one magnetic component is changed by adjusting a magnitude of the magnetic field generated by the one of the at least one magnetic component, in such a manner that a resonance frequency of the vibrator when the vibrator is vibrating is adjusted.

2. The vibration motor as described in claim 1, further comprising:
covers provided at two ends of the shell, respectively,
wherein the at least one magnetic component comprises two magnetic components that are respectively arranged at two inner ends of the shell, each of the two magnetic components is close to one of the covers, each of the two magnetic components is limited at one of the two inner ends of the shell by a limiting block, and the vibrator is capable of vibrating between the two limiting blocks.

3. The vibration motor as described in claim 1, wherein the vibrator is a permanent magnet.

4. The vibration motor as described in claim 1, wherein the at least one magnetic component comprises an iron core, the iron core is embedded in one second coil of the at least one second coil, and the adjustable current is applied to the one second coil in such a manner that a magnetic field generated by the iron core repels the magnetic field generated by the vibrator to provide the restoring force for the vibrator.

5. The vibration motor as described in claim 4, wherein the at least one magnetic component further comprises an iron core-permanent magnet structure, the iron core-permanent magnet structure is formed by splicing an iron core and a permanent magnet and is embedded in one second coil of the at least one second coil, and the adjustable current is applied to the one second coil in such a manner that the magnetic field generated by the iron core-permanent magnet structure repels the magnetic field generated by the vibrator to provide the restoring force for the vibrator.

6. The vibration motor as described in claim 5, wherein the magnitude of the restoring force generated by the one of the at least one magnetic component is changed by adjusting a magnitude of the adjustable current applied to the one second coil, in such a manner that the resonance frequency of the vibrator when the vibrator is vibrating is adjusted; and
each one of the magnitude of the magnetic field generated by the one of the at least one magnetic component, the magnitude of the restoring force provided by the one of the at least one magnetic component to the vibrator, and the resonance frequency of the vibrator when the vibrator is vibrating increases as the magnitude of the adjustable current applied to the one second coil increases.

7. A vibration motor comprising:
a shell having an inner cavity;
a vibrator that is magnetic and received in the inner cavity of the shell;
a magnetic component received in the inner cavity of the shell and configured to drive the vibrator to vibrate;
an elastic component received in the inner cavity of the shell and arranged between the vibrator and the magnetic component;
a first coil fixed to the shell; and
a second coil fixed to the magnetic component,
wherein an alternating current is applied to the first coil in such a manner that the vibrator is driven to vibrate along the inner cavity of the shell, and the vibrator is driven by an elastic force generated by the elastic component to reciprocate in the inner cavity of the shell;
an adjustable current is applied to the second coil in such a manner that a magnetic field generated by the magnetic component is changed to attract or repel a magnetic field generated by the vibrator, to provide an attracting force or a repelling force for the vibrator; and
the attracting force or the repelling force generated by the magnetic component is changed by adjusting a magnitude and a direction of the magnetic field generated by the magnetic component, in such a manner that a resonance frequency of the vibrator when the vibrator is vibrating is adjusted.

8. The vibration motor as described in claim 7, wherein the direction of the magnetic field generated by the magnetic component is changed by adjusting a direction of the adjustable current applied to the second coil in such a manner that the resonance frequency of the vibrator when the vibrator is vibrating is adjusted;
when a current with a first direction is applied to the second coil, the magnetic component generates the repelling force for the vibrator, and the resonance frequency of the vibrator when the vibrator is vibrating increases;
when a current with a second direction is applied to the second coil, the magnetic component generates the attracting force for the vibrator, and the resonance frequency of the vibrator when the vibrator is vibrating decreases; and
the second direction is opposite to the first direction.

9. The vibration motor as described in claim 8, wherein the magnitude of the magnetic field generated by the magnetic component is changed by adjusting a magnitude of the adjustable current applied to the second coil in such a manner that the resonance frequency of the vibrator when the vibrator is vibrating is adjusted;
each one of the magnitude of the repelling force generated by the magnetic component for the vibrator and the resonance frequency of the vibrator when the vibrator is vibrating increases as the current with the first direction applied to the second coil increase; and
each one of the magnitude of the attracting force generated by the magnetic component for the vibrator and the resonance frequency of the vibrator when the vibrator is vibrating decreases as the current with the second direction applied to the second coil decreases.

10. The vibration motor as described in claim 7, wherein the elastic component is a spring.
